(19) United States
(12) Patent Application Publication
(10) Pub. No.: US 2010/0035666 A1
(43) Pub. Date: Feb. 11, 2010

(54) PORTABLE ELECTRONIC DEVICE

(75) Inventors: CHIH-CHIANG CHANG, Shindian (TW); ZHI LI, Shenzhen City (CN); ZHI-YUN SHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/347,251

(22) Filed: Dec. 31, 2008

(30) Foreign Application Priority Data
Aug. 8, 2008 (CN) 200810303596.7

(51) Int. Cl. H04M 1/00

(52) U.S. Cl. 455/575.1

(57) ABSTRACT

A portable electronic device comprises a main body and a battery cover. The main body defines two slots defined therein, the slots is spaced from each other, and the slots is configured to receive a strap therein. The battery cover is configured to cover and secure the strap within the slots.

### CROSS-REFERENCE TO RELATED APPLICATIONS

This application is related to co-pending U.S. Patent Applications (Attorney Docket No. US21755), entitled “PORTABLE ELECTRONIC DEVICE”, by Chih-Chiang Chang et al. The application has the same assignee as the present application and has been concurrently filed herewith.

### BACKGROUND

1. Technical Field

The present invention relates to portable electronic devices, particularly to a portable electronic device with a dangling decorative object, such as a pendant.

2. Description of Related Art

Many portable electronic devices today include dangling decorative objects such as pendants to enhance external appearances and allow personalization. The decorative object may be attached to the electronic device by a strap. The mobile phone defines a hole and the strap may be inserted through the hole and a hole in the decorative object, and the strap circled around and knotted. Thus, the strap forms a loop, thereby hanging the decorative object thereon.

However, it is difficult to insert the strap through the hole because the hole is usually small. Additionally, it is inconvenient to detach the decorative object from the mobile phone by untying the knots.

Therefore, there is room for improvement within the art.

### BRIEF DESCRIPTION OF THE DRAWINGS

Many aspects of the exemplary portable electronic device can be better understood with reference to the following drawings. These drawings are not necessarily drawn to scale, the emphasis instead being placed upon clearly illustrating the principles of the exemplary portable electronic device. Moreover, in the drawings like reference numerals designate corresponding parts throughout the several views. Wherever possible, the same reference numbers are used throughout the drawings to refer to the same or like elements of an embodiment.

FIG. 1 is an illustrative and partially assembled view of a portable electronic device according to an exemplary embodiment.

FIG. 2 is an illustrative view of the portable electronic device in FIG. 1 with a battery cover being detached therefrom.

FIG. 3 is an illustrative view of the portable electronic device of FIG. 2 when a strap being detached therefrom.

### DETAILED DESCRIPTION OF THE EXEMPLARY EMBODIMENTS

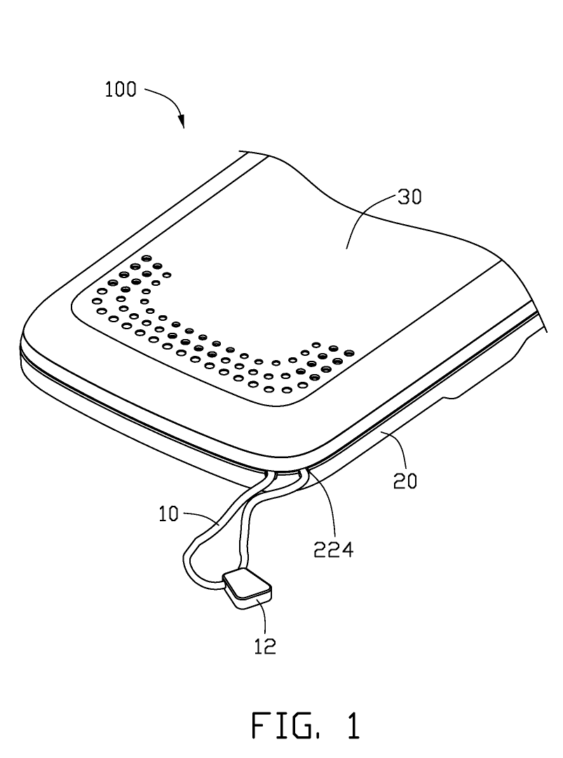

Referring to FIG. 1, a portable electronic device 100 includes a main body 20, a battery cover 30 secured to the main body 20, and a strap 10 secured between the main body 20 and the battery cover 30. The strap 10 may be used for hanging a decorative object 12.

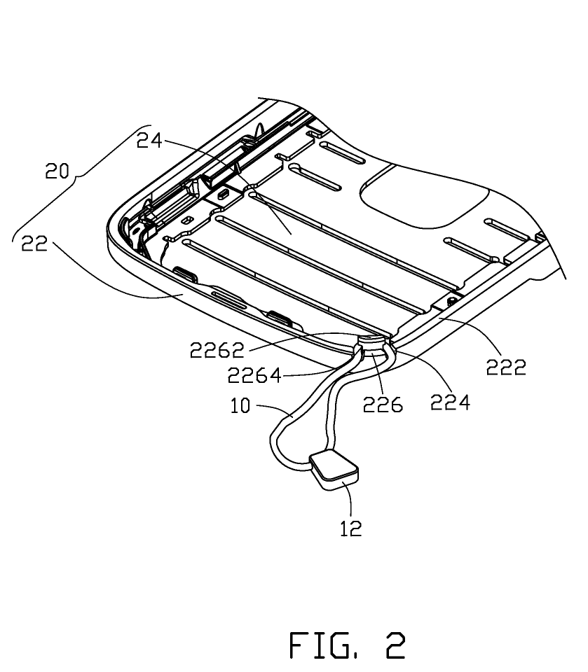

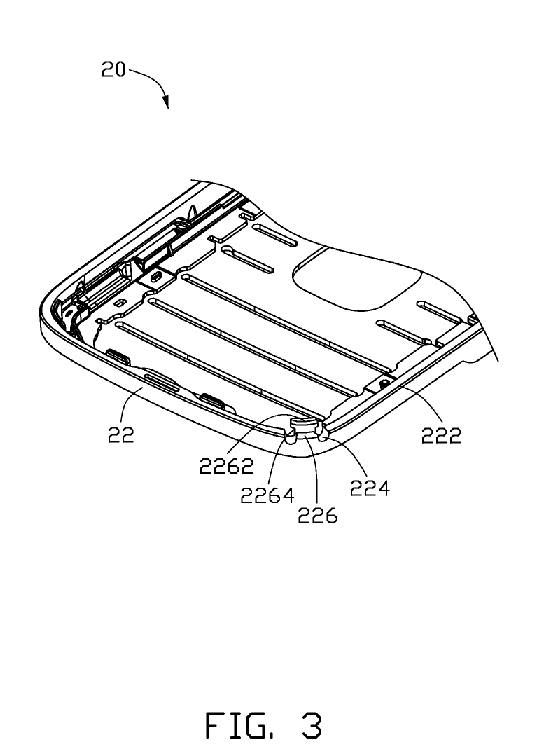

Referring to FIGS. 2 and 3, the main body 20 includes a peripheral wall 22 and a bottom wall 24 connecting the peripheral wall 22. The peripheral wall 22 has a surface 222 facing the battery cover 30. The peripheral wall 22 defines two spaced-apart slots 224. A block 226 is formed between the two slots 224.

The block 226 includes a T-shaped protrusion 2262 extending upwardly from the bottom wall 24, thus two L-shaped latching portions 2264 are formed two opposite ends of the T-shaped protrusion 2262 and extend above the two slot 224, respectively. The strap 10 is configured to be coiled around the block 226 and latched by the latching portions 2264 within the slots 224.

To assemble the strap 10 to the portable electronic device 100, a portion of the strap 10 is coiled around the block 226 and received in the slots 224 with free ends of the strap 10 exposed for securing the decorative object thereto and then knotted. At this time, the strap 10 is latched by the latching portions 2264. After that, the battery cover 30 may be mounted to the main body 20. The battery cover 30 engages with the main body 20 so as to covers the slots 224 and abut tightly against the strap 10, thereby preventing the strap 10 from sliding out of the slots 224. To detach the strap 10 from the portable electronic device 100, simply remove the battery cover 30 from the main body 20 to expose the slots 224. Thus, it is easy to detach the strap 10 from the block 226.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device incorporating a strap for securing a decorative object, comprising:
a main body defining two spaced-apart slots configured to receive the strap therein; and
a battery cover configured to cover and secure the strap within the slots.

2. The portable electronic device as claimed in claim 1, wherein the main body includes a peripheral wall and a bottom wall connecting with the peripheral wall, the peripheral wall has a surface facing the battery cover, the slots is defined in the surface.

3. The portable electronic device as claimed in claim 1, wherein a block is formed between the slots and configured to be coiled around by the strap.

4. The portable electronic device as claimed in claim 3, wherein the block has a T-shaped protrusion extending from a distal end thereof and being configured for preventing the strap from sliding out of the slots.

5. The portable electronic device as claimed in claim 4, wherein two L-shaped latching portions are formed two opposite ends of the T-shaped protrusion and extend above the two slots, respectively to catch the strap.

6. A portable electronic device incorporating a strap for securing a decorative object, comprising:
a main body including a peripheral wall and a bottom wall connecting with the peripheral wall, the peripheral defining two spaced-apart slots configured to receive the strap therein, the bottom wall has a T-shaped protrusion extending therefrom with two opposite end extending above the two slots to catch the strap; and
a battery cover engaging with the main body to cover the slots to prevent the strap from sliding out of the slots.

7. The portable electronic device as claimed in claim 6, wherein the peripheral wall has a surface facing the battery cover, the slots defined in the surface.

8. The portable electronic device as claimed in claim 6, wherein a block is defined between the slots and configured to be coiled around the block.

9. The portable electronic device as claimed in claim 8, wherein the T-shaped protrusion also extends from a distal end of the block and is configured for protrusion preventing the strap from sliding out of the slots.

10. A portable electronic device, comprising:
a main body including a peripheral wall and a bottom wall connecting with the peripheral wall, the peripheral defining two spaced-apart slots and having a block formed between the slots;
a battery cover engaging with main body and covering the slots; and
a strap configured for being received in the slots and coiling around the block.

11. The portable electronic device as claimed in claim 10, wherein the battery cover configured to cover and secure the strap within the slots.

12. The portable electronic device as claimed in claim 10, wherein the peripheral wall has a surface facing the battery cover, the slots defined in the surface.

13. The portable electronic device as claimed in claim 10, wherein two L-shaped latching portions are formed two opposite ends of the T-shaped protrusion and extend above the two slot, respectively to catch the strap.
